(19) United States
(12) Patent Application Publication
(10) Pub. No.: US 2014/0258409 A1
(43) Pub. Date: Sep. 11, 2014

(54) METHOD, SERVER AND BROWSER FOR PUSHING MESSAGE ACTIVELY

(71) Applicant: Tencent Technology (Shenzhen) Company Limited, Shenzhen (CN)

(72) Inventor: Yi TANG, Shenzhen (CN)

(73) Assignee: Tencent Technology (Shenzhen) Company Limited, Shenzhen (CN)

(21) Appl. No.: 14/284,695

(22) Filed: May 22, 2014

Related U.S. Application Data
(63) Continuation of application No. PCT/CN2013/086697, filed on Nov. 7, 2013.

(30) Foreign Application Priority Data
Jan. 30, 2013 (CN) 201310036064.2

(51) Int. Cl. H04L 29/08

(52) U.S. Cl. CPC H04L 67/26
USPC 709/204

(57) ABSTRACT

Described are a method, server and browser for pushing a message actively, the method includes: establishing by the server a long connection with the browser; receiving the identification ID reported by the browser through the established long connection; sending the corresponding Push message to the browser in real time according to the identification ID. The present method raises the user's value through the Push Tips message, and presents favorite and useful content to the user at suitable time and site, which provides a personalized service, or it activates the user and increases liveness of the user by pushing content of the upgraded application to user of the webpage application, and it implements receiving/processing/presenting the Push message sent actively by the backstage server at the browser, without the client refreshing and sending a request continuously, which increases timeliness and efficiency of acquiring information by the user.

### CROSS-REFERENCE TO RELATED APPLICATIONS

This application is a U.S. continuation application under 35 U.S.C. §111(a) claiming priority under 35 U.S.C. §§120 and 365(c) to International Application PCT/CN2013/086697 filed on Nov. 7, 2013, which claims the priority benefit of Chinese Patent Application No. 201310036064.2 filed on Jan. 30, 2013, the contents of which are incorporated by reference herein in their entirety for all intended purposes.

### TECHNICAL FIELD

The present disclosure relates to field of internet technique, in particular relates to method, server and browser for pushing message actively.

### BACKGROUND

With the development of the mobile internet technique, user's demand for real-time of data become more, for example, many applications such as a monitoring, an instant communication, a smart input system need to transmit a variation generated at backstage to a client in real time, and the client does not need to refresh and send a request continuously.

However, the conventional information transmission technique is mainly a pull technique, where the client sends message to the backstage server actively and the backstage server transmits information to the browser of the client when the request sent by the client is received according to a pre-defined setting file instead of transmitting information according to the real-time requirement of the user.

In the pull technique, the user usually searches on the internet by using the browser. On one hand, many users take quite a lot of time and expense but are difficult to pull information needed by themselves for a large amount of information; and on the other hand, information issuers also wish to send information to an interested client actively and in real time instead of waiting the user to pull.

Therefore, it is necessary to provide an information push technique for sending information to the client by the server actively to increase timeliness and efficiency of acquiring information by the user.

### SUMMARY

Embodiments of the present invention is to provide method, server and browser for pushing a message actively to increase timeliness and efficiency of acquiring information by the user, so as to provide the user with a personalized service and increase liveness of the user.

One embodiment of the present invention provides a method for pushing a message actively including:

Establishing a long connection with a browser by a server;

Receiving an identification ID of a webpage application added on the browser, which is reported by the browser through the established long connection; and

Sending a corresponding push message to the browser in real time according to the identification ID of the webpage application.

Another embodiment of the present invention also provides a server for pushing a message actively including:

A connection establishing module configured to establish a long connection between the server and the browser;

A receiving module configured to receive an identification ID of a webpage application added on the browser, which is reported by the browser through the established long connection; and

A pushing module configured to send a corresponding push message to the browser in real time according to the identification ID of the webpage application.

Yet another embodiment of the present invention provides a browser for pushing a message actively including:

A reporting module configured to, after establishing the long connection with the server, report an identification ID of a webpage application added on the browser to the server through the established long connection; and

A display module configured to receive and display the corresponding push message sent in real time by the server according to the identification ID of the webpage application.

In the method, server and browser for pushing message actively provided by the embodiments of the present invention, by establishing the long connection between the backstage server and the browser, the browser reports the identification ID of the webpage application added on the browser for acquiring a push message to the backstage server and the backstage server sends the corresponding push message to the browser according to the identification ID of the webpage application reported by the browser. Further, the identification ID is also global unique identification ID of the browser for acquiring a Tips message, the backstage server transmits information according to the real-time requirement of the user. Thereby, not only the value of the user is increased, and also favorite and useful content is presented to the user at suitable time and site, it provides a personalized service or activates user by pushing upgraded application content to the user of the webpage application, and increases liveness of the user, and also, receiving/processing/presenting Push message sent by the backstage server actively at the browser is implemented without the client refreshing and sending request continuously, which increases timeliness and efficiency of acquiring information by the user.

### BRIEF DESCRIPTION OF THE DRAWINGS

FIG. 1 is a schematic diagram of a flow of a preferable embodiment of the method for pushing a message actively of the present invention;

FIG. 2 is a schematic diagram of an interface of a pushing Tips message on the user browser page of the browser of the mobile phone by the backstage server in the embodiments of the present invention;

FIG. 3 is a schematic diagram of an example of implementing a webpage application push message on the browser of the mobile phone by the backstage server in the embodiments of the present invention;

FIG. 4 is a schematic diagram of a structure of preferable embodiment of the server for pushing message actively of the present invention;

FIG. 5 is a schematic diagram of a structure of preferable embodiment of the browser for pushing a message actively of the present invention.

In order to make the technical solution of the present invention more clear and explicit, it is described in combination with the accompanying drawings as follows.

### DETAILED DESCRIPTION

The concept of the embodiments of the present invention is of: reporting the identification ID of the webpage application added on the browser for acquiring a Push message to the backstage server by the browser through establishing a long connection between the backstage server and the browser, and sending the corresponding Push message to the browser by the backstage server according to the identification ID reported by the browser and according to a real-time requirement of the user, to implement receiving/processing/presenting the Push message sent actively by the backstage server at the browser, without the client refreshing and sending request continuously, which increases timeliness and efficiency of acquiring information by the user.

As shown in FIG. 1, the preferable embodiment of the present invention provides a method for pushing a message actively, the method is as follows.

Step S101 is establishing a long connection with the browser by the server;

Wherein, the long connection is a connection established between the backstage server and the browser through which the message can be received and sent multiple times rather than establishing a connection every time the message is received and sent, so it is called a long connection.

As compared with the conventional pull technique, the present embodiment adopts a mechanism of the backstage server (at service side) pushing actively. As compared with the conventional pull technique, the most difference is that the push technique transmits information actively to the client by the server, and the advantage of the push technique is the initiative and timeliness of the information.

The push message (Push message) referred in the present embodiment may be a push Tips message and a webpage application (WebApp) push message or the like.

Wherein, the Tips message is data or reminder for reference, information for prompting others, and the push Tips message is mainly for presenting a favorite and useful content (personalized content) for the user at suitable time and site. For example, a prompt bar is appeared at the client side to prompt information content that the user may be interested in or concerned according to different time and site.

The function of the webpage application Push is to activate the user and increase liveness of the user by pushing an upgraded application content to the user of the webpage application. The usual webpage application that needs to be pushed are for example, micro-blog, Qzone and message box or the like.

The browser referred in the present embodiment may be the browser at PC side, or the browser in the mobile terminal, the mobile terminal may be a mobile phone, a tablet computer or the like.

A long connection to the backstage server for pushing is established automatically after the browser is initiated, and then the browser and the backstage server can carry out the data transmission through the established long connection.

Step S102 is receiving the identification ID reported by the browser through the established long connection;

Wherein, corresponding to application scene of push Tips message, the identification ID reported by the browser is a global unique identification ID of the browser which may be defined as guid (GUID, Globally Unique Identifier). And, corresponding to application scene of webpage applications Push message, the identification ID reported by the browser is a webpage application ID added by the browser which may be defined as appid (APPID, Application Identifier).

In particular, when the webpage applications are added, the browser is associated with the webpage applications at the backstage, and an icon of the webpage application is added on the browser. And, in specific implementation, the icon of the webpage application can be add on a head page or a non-head page of the browser, or added in other manners.

Step S103 is sending the corresponding Push message to the browser in real time according to the identification ID.

The backstage server sends the Tips message to the browser in real time according to the global unique identification ID of the browser after acquiring the identification ID reported by the browser; or sends the Push message corresponding to the webpage application ID in real time according to the webpage application ID added by the browser.

Corresponding to an application scene of the webpage application Push message, the Push backstage server detects whether the webpage application has information upgraded in real time. And, if there is information upgraded, it pulls data from the backstage server for the webpage application or receives information upgrading data reported actively by the backstage server for the webpage application, and pushes the information upgrading data to the browser to be displayed according to the identification ID of the webpage application.

A flow of pushing Tips (Push Tips) and A flow of pushing webpage application (webpage application Push) on the browser of the mobile phone are described detailed by taking the browser of the mobile phone as example as follows.

Corresponding to an application scene of the backstage server pushing Tips message to the browser of the mobile phone, the specific processing flow is as follows:

The browser of the mobile phone establishes a long connection to the Push backstage server after being initiated, and then the browser of the mobile phone reports the global unique identification ID of itself to the Push backstage server; and the Push backstage server sends the corresponding Tips content to the browser of the mobile phone according to the identification ID and according to the real-time requirement of the user.

Here, the content of the Tips message may include the following content: text of the message, URL (uniform resource locator) to which the user turns when the user clicks a text region on a browse page of the browser of the mobile phone, an icon of the message and a duration during which the message needs to be displayed on the user's interface.

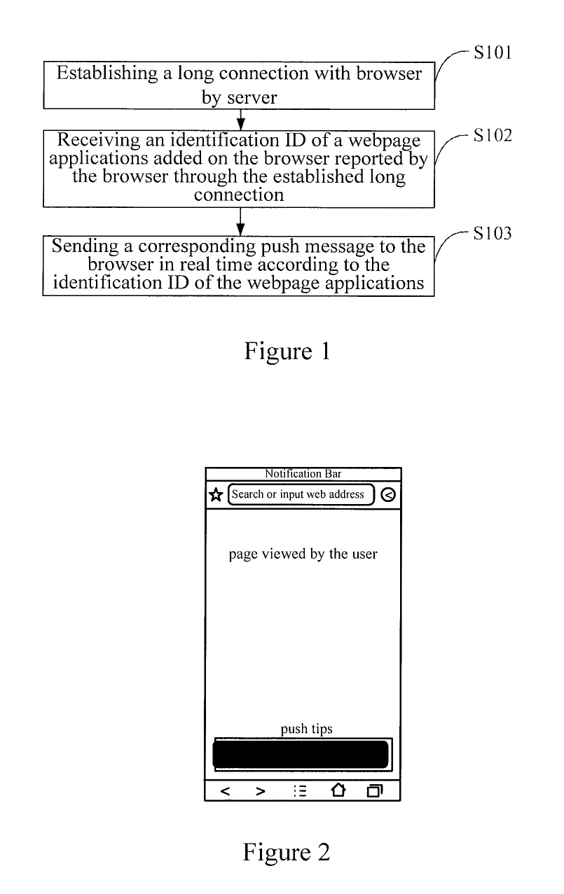

As shown in FIG. 2, FIG. 2 is a schematic diagram of an interface of the backstage server pushing the Tips message on the user browse page of the browser of the mobile phone.

After the browser of the mobile phone receives the Tips message, the Tips message is presented at specified box position in FIG. 2, and at this time, if the user clicks the text content in the specified box, he turns to the corresponding URL.

Thereby, the favorite and useful content is presented to the user at suitable time and site with the Push Tips message, which provides a personalized content service to the user.

Corresponding to an application scene in which the Push backstage server pushes the Push message to a webpage application added in the browser of the mobile phone, the specific processing flow thereof is as follows:

First, the browser of the mobile phone adds the webpage application to the head page or other pages of the browser of the mobile phone according to the user's operation, and generates a shortcut icon in a corresponding page of the browser of the mobile phone, then the browser of the mobile phone reports the added webpage application ID to the Push backstage server for the webpage application, the backstage server sends the corresponding Push message to the browser of the mobile phone according to the real-time requirement of the user through the established long connection.

Here, the Push message may include the following content:

Webpage application ID through which the browser of the mobile phone finds the webpage application in corresponding page of the browser;

Text at upper right corner on the webpage application page which may be number of pieces of message or reminder message showing that there is new content; and

Background picture acquired by the browser through the Push message and used to replace the currently default background picture of the webpage application after opening the webpage application page.

The browser of the mobile phone upgrades the webpage application Push information added onto the browser according to the webpage application ID. Wherein, the browser can display the push message on the icon of the webpage application, or pop-up the push message on a page at which the webpage application is.

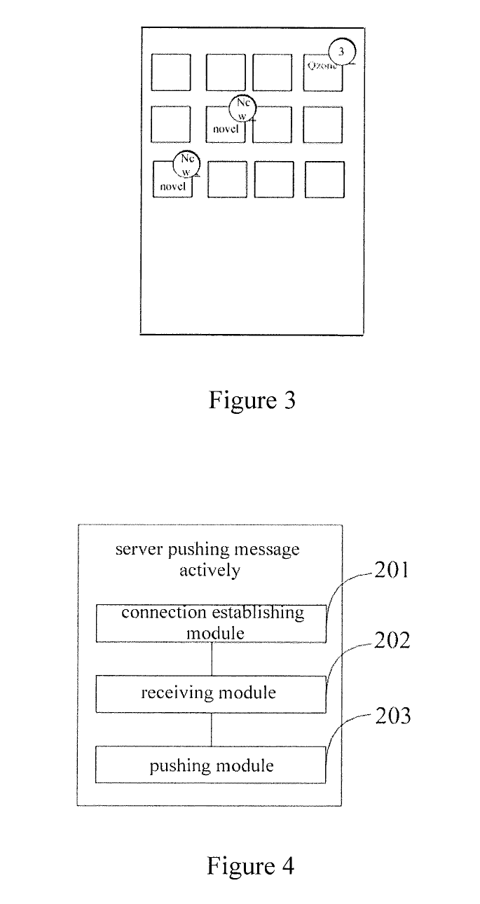

As above mentioned, the function of the webpage application Push is to activate the user and increase liveness of the user by pushing the content of the upgraded application to the user of the webpage application, the usual webpage application that needs to be pushed is for example micro-blog, Qzone and message box or the like, as shown in FIG. 3. FIG. 3 is a schematic diagram of an example of the webpage application Push message.

Taking a webpage application of Qzone in FIG. 3 as example, first, the browser of the mobile phone is associated with the backstage server of Qzone, the icon of Qzone is added on head page of the browser of the mobile phone (for example, as shown in the upper right corner of FIG. 3). Then, the browser of the mobile phone reports the identification ID of Qzone to the Push backstage server after the browser of the mobile phone establishes the long connection with the Push backstage server.

The Push backstage server detects in real time whether Qzone has information upgraded, and if there is information upgraded, it pulls data from the backstage server of Qzone or receives the information upgrading data reported actively by the backstage server of Qzone, and pushes the information upgrading data to the browser of the mobile phone to be displayed according to the identification ID of Qzone. For example, if there are three reminder messages in Qzone, the number of pieces of message is displayed in a corresponding message icon at the upper right corner of the icon of Qzone on the page on which the browser of the mobile phone adds Qzone, as shown in FIG. 3, in which there displays three reminder messages of Qzone. And, if the user is interested in the information upgrading of Qzone, he can click the message icon to enter the page in which Qzone is to view the updated information. Thereby, the user is made to acquire an interested push service in time without the client refreshing and sending the request continuously, which increases timeliness and efficiency of acquiring information by the user.

The above-described Push technique adopted by the present embodiment is different from the conventional Pull technique of searching by using the browser in that, the Push technique is to send actively the information that the user is interested in to the browser of the user side in time and with a purpose according to user's requirement. This active push technique can reduce the time for the user to search for information. On the other hand, it also satisfies the requirement that the information issuer wishes to sent the information to the interested user computer in time and actively. Since the backstage server transmits information according to the real-time requirement of the user, thereby, it raises the user's value by Push Tips message and presents the favorite and useful content to the user at suitable time and site, which provides a personalized service or activates user and increases liveness of the user by pushing the content of the upgraded application to the user of the webpage application, and it implements receiving/processing/presenting the Push message sent actively by the backstage server at the browser, so that the user is made to acquire an interested push service in time without the client refreshing and sending the request continuously, which increases timeliness and efficiency of acquiring information by the user.

As shown in FIG. 4, the preferable embodiment of the present invention provides a server for pushing message actively. The server includes a connection establishing module 201, a receiving module 202 and a pushing module 203.

The connection establishing module 201 is configured to establish a long connection between the server and the browser.

The receiving module 202 is configured to receive the identification ID of the webpage application added on the browser reported by the browser through the established long connection.

The pushing module 203 is configured to send the corresponding push message to the browser in real time according to the identification ID of the webpage applications.

Wherein, the long connection is a connection established between the backstage server and the browser through which the message can be received and sent multiple times rather than establishing a connection every time the message is received and sent, so it is called a long connection.

As compared with the conventional pull technique, the present embodiment adopts a mechanism of the backstage server (service side) pushing actively. As compared with the conventional pull technique, the most difference is that the push technique transmits information actively to the client by the server, and the advantage of the push technique is the initiative and timeliness of the information.

Further, the receiving module 202 is also configured to receive a global unique identification ID of the browser reported by the browser;

The pushing module 203 is also configured to send a Tips message to the browser according to the global unique identification ID of the browser.

In particular, the push message referred in the present embodiment may include a push Tips message and a webpage application (WebApp) push message or the like.

Wherein, the Tips message is data or reminder for reference, information for prompting others, the push Tips message is mainly for presenting the favorite and useful content (a personalized content) for the user at suitable time and site, which displays a prompt bar actively at the client to prompt information content that the user may be interested in or concerned according to different time and site.

The function of the webpage application Push is to activate user and increase liveness of the user by pushing the content of the upgraded application to the user of the webpage application, the usual webpage applications that need to be pushed are for example, micro-blog, Qzone and message box or the like.

The browser referred in the present embodiment may be the browser in PC side, and also the browser in the mobile terminal, the mobile terminal may be a mobile phone, an iPad or the like.

The long connection to the Push backstage server is established automatically after the browser initiates, the server establishes the long connection with the browser by the connection establishing module 201. And then, the receiving module 202 receives the identification ID reported by the browser through the established long connection.

Wherein, corresponding to the application scene of push Tips message, the identification ID reported by the browser is a global unique identification ID of the browser which may be defined as guid. And, corresponding to the application scene of webpage applications Push message, the identification ID reported by the browser is webpage applications ID added by the browser which may be defined as appid.

In particular, when the webpage application is added, the browser is associated with the webpage application at the backstage, an icon of the webpage application is added on the browser. And, in specific implementation, the icon of the webpage application can be add on the head page or the non-head page of the browser, or added in other manners.

The pushing module 203 of the server sends the Tips message to the browser in real time according to the global unique identification ID of the browser after the server acquires the identification ID reported by the browser; or sends the Push message corresponding to the webpage applications ID in real time according to the webpage applications ID added by the browser.

Corresponding to the application scene of webpage applications Push message, the Push backstage server detects whether the webpage application has information upgraded in real time. And, if there is information upgraded, it pulls data from the backstage server for the webpage applications or receives information upgrading data reported actively by the backstage server for the webpage applications, and pushes the information upgrading data to the browser to be displayed according to the identification ID of the webpage applications.

The flow of Push Tips and the flow of webpage applications Push on the browser of the mobile phone are described detailed by taking the browser of the mobile phone as example as follows.

Corresponding to the application scene of the backstage server pushing Tips message to the browser of the mobile phone, the specific processing flow thereof is as follows:

The browser of the mobile phone establishes the long connection to the Push backstage server after being initiated; and then the browser of the mobile phone reports the own global unique identification ID to the Push backstage server. The Push backstage server sends the corresponding Tips content to the browser of the mobile phone according to the identification ID and according to the real-time requirement of the user.

Here, the content of the Tips may include the following content: the text of the message, the URL to which the user turns when the user clicks the text region on the browse page of the browser of the mobile phone, the icon of the message and the duration during which the message needs to be displayed on the user's interface.

As shown in FIG. 2, FIG. 2 is a schematic diagram of an interface of the backstage server for pushing Tips message on the user browse page of the browser of the mobile phone.

After the browser of the mobile phone receives the Tips message, the Tips message is present at a specified box position in FIG. 2, and at this time, the user turns to the corresponding URL when the text content in the specified box is clicked by the user.

Thereby, the user is cared for and greeted by the Push Tips message to raise the user's value and public praise, and the favorite and useful content is presented to the user at suitable time and site, which provides a personalized content service to the user.

Corresponding to the application scene in which the Push backstage server pushes the Push message to the webpage application added in the browser of the mobile phone, the specific processing flow thereof is as follows:

First, the browser of the mobile phone adds the webpage application to the head page or other pages of the browser of the mobile phone according to the user's operation, and generates a shortcut icon in the corresponding page of the browser of the mobile phone, then the browser of the mobile phone reports the added webpage application ID to the Push backstage server for the webpage application, the backstage server sends the corresponding Push message to the browser of the mobile phone according to the real-time requirement of the user through the established long connection.

Wherein, the Push message may include the following content:

A webpage application ID through which the browser of the mobile phone finds the webpage application in the corresponding page of the browser;

A text at the upper right corner on the webpage application page which may be number of pieces of message or reminder message showing that there is new content;

A background picture acquired by the browser through the Push message and may be used to replace the currently default background picture of the webpage application after opening the webpage application page.

The browser of the mobile phone upgrades the webpage application Push information added onto the head page of the browser according to the webpage application ID. Here, the browser can display the push message on the icon of the webpage application, or pop-up the push message on a page at which the webpage application is.

As above mentioned, the function of the webpage application Push is to activate the user and increase liveness of the user by pushing upgraded content of the application to the user of the webpage application, the usual webpage applications that needs to be pushed are for example micro-blog, Qzone and message box or the like, as shown in FIG. 3. FIG. 3 is a schematic diagram of an example of the webpage application Push message.

Taking the webpage application of Qzone in FIG. 3 as example, first, the browser of the mobile phone is associated with the backstage server of Qzone, the icon of Qzone is added on the head page of the browser of the mobile phone (for example, as shown in the upper right corner of FIG. 3). Then, the browser of the mobile phone reports the identification ID of Qzone to the Push backstage server after the browser of the mobile phone establishes the long connection with the Push backstage server.

The Push backstage server detects in real time whether Qzone has information upgraded, and if there is information upgraded, it pulls data from the backstage server of Qzone or receives information upgrading data reported actively by the backstage server of Qzone, and pushes the information upgrading data to the browser of the mobile phone to display according to the identification ID of Qzone. For example, there are three reminder messages in Qzone, the number of pieces of message is displayed in the corresponding message icon at the upper right corner of the icon of Qzone on the page on which the browser of the mobile phone adds Qzone, as shown in FIG. 3, there displays three reminder messages of Qzone. If the user is interested in the information upgrading of Qzone, he can click the message icon to enter the page in which Qzone is to view the updated information. Thereby, the user is made to acquire a interested push service in time without the client refreshing and sending the request continuously, which increases timeliness and efficiency of acquiring information by the user.

The above-described Push technique adopted by the present embodiment is different from the conventional Pull technique of searching by using the browser in that, the Push technique is to send actively the information that the user is interested in to the browser of the user side in time and with a purpose according to user's requirement. This active push technique can reduce the time for the user to search for information; and on the other hand, it also satisfies the requirement that the information issuer wishes to sent the information to the interested user computer in time and actively. Since the backstage server transmits information according to the real-time requirement of the user, it raises the user's value by the Push Tips message, and presents the favorite and useful content to the user at suitable time and site, which provides a personalized service, or activates user and increases liveness of the user by pushing the content of the upgraded application to the user of the webpage application, and it implements receiving/processing/presenting the Push message sent actively by the backstage server at the browser, so that the user is made to acquire the interested push service in time without the client refreshing and sending the request continuously, which increases timeliness and efficiency of acquiring information by the user.

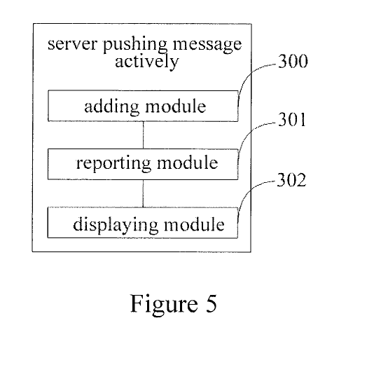

As shown in FIG. 5, the preferable embodiment of the present invention provides a browser for pushing a message actively. The browser includes an adding module 300, a reporting module 301 and a display module 302.

The adding module 300 is for adding the webpage application on the browser.

In particular, when the webpage applications are added, the browser is associated with the webpage application at the backstage, an icon of the webpage application is added on the browser, and in specific implementation, the icon of the webpage application can be add on the head page or the non-head page of the browser, or added in other manners.

The reporting module 301 is configured to report an identification ID of a webpage applications added on the browser to the server through the established long connection after establishing the long connection with the server;

The display module 302 is configured to receive and display the corresponding push message sent in real time by the server according to the identification ID of the webpage applications.

The server in the present embodiment refers to the Push backstage server, the basic principal of the server in the present embodiment pushing a message actively to the browser can be with reference to the above-described respective embodiments, and it is no longer described here.

In the method, the server and the browser for pushing a message actively of the embodiments of the present invention, the browser reports the identification ID for acquiring a Push message to the backstage server by establishing a long connection between the backstage server and the browser, the backstage server sends the corresponding Push message to the browser according to the identification ID reported by the browser, wherein, the identification ID may be a global unique identification ID of the browser for acquiring the Tips message or a webpage application ID for acquiring the Push message of the webpage application, the backstage server transmits information according to the real-time requirement of the user, thereby, the user's value is raised through the Push Tips message, and favorite and useful content is presented to the user at suitable time and site, which provides a personalized service, or it activates user and increases liveness of the user by pushing the content of the upgraded application to the user of the webpage application, and it implements receiving/processing/presenting the Push message sent actively by the backstage server at the browser side, without the client refreshing and sending the request continuously, which increases timeliness and efficiency of acquiring information by the user.

The above mentioned is only preferred embodiment of the present invention and therefore not limit scope of the present invention, the equivalent structure or flow transition made by using the content in the specification and accompanying drawings of the present invention or direct or indirect application in other related technical field are included within the scope of patent protection of the present invention in same way.

1. A method for pushing a message actively, comprising:
establishing a connection with a browser by a server;
receiving an identification of a webpage application added on the browser reported by the browser through the established long connection;
sending a corresponding push message to the browser according to the identification of the webpage applications.

2. The method according to claim 1, wherein the step of sending the corresponding push message to the browser in real time according to the identification of the webpage applications comprises:
monitoring, by the server, whether the webpage application has information upgraded according to the identification of the webpage applications;
pulling data from the backstage server of the webpage application or an information upgrading data reported actively by the backstage server of the webpage applications in case that the webpage application has information upgraded;
pushing the information upgrading data to the browser to be displayed according to the identification of the webpage applications.

3. The method according to claim 2, wherein the content of the push message corresponding to the webpage application includes at least one of the following: a webpage application, a webpage application page reminder message and a background picture.

4. The method according to claim 1, further comprises:
receiving, by the server, a global unique identification of the browser reported by the browser;
sending, by the backstage server, a tips message to the browser according to the global unique identification of the browser.

5. The method according to claim 4, wherein the content of the tips message includes at least one of the following: text of the message, a uniform resource locator to which the user turns when the user clicks the text region on the browse page of the browser of the mobile phone, an icon of the message and a duration during which the message needs to be displayed on the user's interface.

6. A server for pushing a message actively, comprising:
a connection establishing module configured to establish a connection between the server and a browser;
a receiving module configured to receive an identification of a webpage applications added on the browser reported by the browser through the established long connection;
a pushing module configured to send a corresponding push message to the browser according to the identification of the webpage applications.

7. The server according to claim 6, wherein the pushing module is further configured to monitor whether the webpage application has information upgraded according to the identification of the webpage applications, in case that the webpage application has information upgraded, pull data from the backstage server for the webpage applications or receive information upgrading data reported actively by the backstage server for the webpage applications; and push the information upgrading data to the browser to be displayed according to the identification of the webpage applications.

8. The server according to claim 6, wherein
the receiving module is further configured to receive a global unique identification of the browser reported by the browser;
the pushing module is further configured to send a tips message to the browser according to the global unique identification of the browser.

9. A browser for pushing message actively, comprising:
a reporting module configured to report an identification of a webpage applications added on the browser to the server through a established long connection after establishing the long connection with server;
a display module configured to receive and display a corresponding push message sent by the server according to the identification of the webpage applications.

10. The browser according to claim 9, further comprises:
an adding module configured to add the webpage application on the browser.

11. The browser according to claim 10, wherein the manner of the adding module adding the webpage applications includes at least: adding an icon of the webpage application in the head page of the browser.

12. The browser according to claim 10, wherein the manner of the display module displaying the push message includes at least one of the following: displaying the push message on the icon of the webpage application; or displaying a pop-up that includes the push message on a page at which the webpage application is.

13. The browser according to claim 10, wherein
the reporting module is further configured to report a global unique identification of the browser to the server;
the display module is further configured to receive and display the tips message sent by the server according to the global unique identification of the browser.
